(19) United States
(12) Patent Application Publication
(10) Pub. No.: US 2004/0174704 A1
(43) Pub. Date: Sep. 9, 2004

(54) Light source module and method for design the same

(76) Inventors: Chuan-Yu Hsu, Hsinchu (TW); Chih-Wen Huang, Hsinchu (TW)

Correspondence Address: J.C. Patents, Inc., Suite 250, 4 Venture, Irvine, CA, 92618, US

(21) Appl. No.: 10/606,014

(22) Filed: Jun. 24, 2003

(30) Foreign Application Priority Data
Mar. 4, 2003 (TW) 92104496

(51) Int. Cl. F21S 4/00

(52) U.S. Cl. 362/217

(57) ABSTRACT

Light source module mainly comprises a reflector and a lamp is provided. The reflector comprises a light output section, and a portion of the reflector corresponding to the light output section comprises at least one protrusion. The lamp is disposed in the reflector, and the light emitted by the lamp is reflected onto other portions of the reflector via the protrusions of the reflector, and then output from the light output section. Further, a portion of the reflector corresponding to the light output section is designed as a curve F, and a portion of the reflector adjacent to the light output section is designed as a reflective surface S. The curve F is connected to the reflective surface S, and the curve F=∫dFdS=∫(ax+by+c)dS, wherein dF is a differential plane that constructs the curve F, dS is a differential plane that constructs the reflective surface S, and (a, b) is a normal vector of the differential plane dF. With such design, the light source utilization efficiency is effectively improved.

### CROSS-REFERENCE TO RELATED APPLICATION

This application claims the priority benefit of Taiwan application serial no. 92104496, filed Mar. 4, 2003.

### BACKGROUND OF THE INVENTION

1. Field of Invention

The present invention generally relates to a light source module and a method for designing the same, and more particularly, to a reflector ofthe light source module and a method for designing the same.

2. Description of Related Art

Following the great progress of computer performance and high-level development of the Internet and multimedia technologies, image information has been delivered by using digital transmission instead of analog transmission. Along with the trend of the image digitalization, versatile products related to digital transmission and storing, such as Digital Camera (DC), Digital Video Camera (DV), scanner, have been developed and have come out. However, besides the DC and the DV being used for directly capturing image pictures, other image digitalization operations related to documents or pictures all use the scanner to capture analog images of a character or a picture, and convert them to digital signals for outputting. Digitalization assists users in performing the operations of displaying documents, Optical Character Recognition (OCR), editing, storing, and outputting on computer or other electronic products.

When performing the document or picture image scanning, a light provided by the source module inside the scanneris emitted onto the document or picture, then the light (image) reflected from the document or picture is emitted into the scanning module inside the scanner and is finally captured by the image capturing device. Since the light intensity provided by the light source module during the scanning process directly impacts the digital image output result, the light source utilization efficiency is always a major concern of the designers in the related art.

FIG. 1 schematically shows a structure diagram of a conventional light source module. Referring to FIG. 1, the conventional light source module 100 mainly comprises a reflector 102 and a lamp 104. Wherein, the lamp 104 is disposed inside the reflector 102, and the light emitted by the lamp 104 is output from the light output section 102a via curve design of the reflector 102. The light focused by the reflector 102 emits on the document 108, and the light reflected by the document 108 is then emitted into the optical scanning module of the scanner. The document 108 mentioned above is, for example, placed on a document plate 106 of the scanner housing for performing the scanning operation, and the document plate 106 for placing the document 108 is generally made of a transparent material, so that the light (image) can be easily reflected from the document 108, and then captured by the optical scanning module.

Referring to FIG. 1, the general reflector 102 is designed as a form of an ellipse curve or a parabolic curve; most of the light emitted by the tube of the lamp 104 is output from the curve design of the reflector 102. However, since the lamp 104 is disposed in the reflector 102 and the lamp 104 has a certain diameter, after the light emitted from the surfaceof the lamp 104 far from the light output section 102a is reflected, the light is blocked by the lamp 104. In other words, since the light emitted by the lamp 104 is not fully utilized, the light source utilization efficiency of the light source module is poor.

From the descriptions mentioned above, the reflector 104 with ellipse or parabolic curve design can not effectively output all lights emitted by the lamp 102 via the light output section 102a. Meanwhile, in order to improve the poor light source utilization efficiency problem, the tube diameter of the lamp can be reduced. However, doing so will incur the cost increase problem in designing, manufacturing, and assembly.

### SUMMARY OF THE INVENTION

To solve the problem mentioned above, the object of the present invention is to provide a light source module that can effectively improve the light source utilization efficiency and the method for design the same.

In order to achieve the object mentioned above, the light source module provided by the present invention mainly comprises a reflector and a lamp. The reflector comprises a light output section, and the portion of the reflector corresponding to the light output section comprises at least one protrusion. The lamp is disposed in the reflector, and the light emitted from the lamp is reflected by the protrusions to another portion of the reflector and then output from the light output section.

In order to achieve the object mentioned above, the light source module provided by the present invention comprises a reflector and a lamp. The reflector comprises a light output section, wherein the portion of the reflector corresponding to the light output surface is a curve F, and the portion of the reflector adjacent to the light output section is a reflective surface S. The curve F is connected to the reflective surface S, and the curve F=∫dFdS=∫(ax+by+c)dS, wherein dF is a differential plane which constructs the curve F, dS is a differential plane which constructs the reflective surface, and (a, b) is the normal vector of the differential plane dF. The lamp is disposed in the reflector, and the light emitted by the lamp is reflected by the curve F at least one time, then delivered to the reflective surface S, and finally output via the light output section.

In order to achieve the object mentioned above, a method for designing the light source module is provided by the present invention. The method provides a reflector, which comprises a light output section. The portion of the reflector corresponding to the light output section is designed as a curve F, and the portion of the reflector adjacent to the light output section is designed as a reflective surface S that is connected to the curve F. The curve F satisfies the following equation, F=∫dFdS=∫(ax+by+c)dS, wherein dF is a differential plane which constructs the curve F, dS is a differential plane which constructs the reflective surface, and (a, b) is the normal vector of the differential plane dF. Then, a lamp is disposed in the reflector, and the linear light source (lamp) is extended in parallel with z axis, so that the light emitted by the lamp is reflected by the curve F at least one time, then delivered to the reflective surface S, and finally output via the light output section.

In the light source module, the method for design is the same according to the present invention mentioned above. The curve F can be deducted from the step (a) to step (e) as follows:

(a) Assuming that the equation of the reflective surface S is known, in the present embodiment, the reflective surface S is, for example, assumed as an ellipse curve or a parabolic curve, or a plane.

(b) The differential plane dF is related to vectors \vec{A}, \vec{B}, \vec{C}, wherein \vec{A} is a proceeding vector of the light emitted from each unit area on the back of the lamp; \vec{B} is a proceeding vector of the light reflected from each unit of the differential plane dS when the document is being scanned; and \vec{C} is a reflective vector of \vec{B} corresponding to each unit area of dS on the reflective surface S.

(c) Calculate a angle bisect vector according to two vectors \vec{A} and \vec{C}, the angle bisectvector is the normal vector dN of the differential plane dF. Assuming that the calculated normal vector dN is (a, b) and is on the X-Y plane, the equation of differential plane dF is assumed as ax+by+c=0.

(d) Calculating a focal point M from two vectors \vec{A} and \vec{C}, since the focal point M is on the differential plane dF, the coordinate of focal point M is brought into ax+by+c=0, so as to calculate a value of c.

(e) Performing integration for differential plane dF on dS, and providing an appropriate boundary condition, so as to obtain an equation of curve F, i.e. F=∫dFdS=∫(ax+by+c)dS. However, in step (e), the equation of curve F also can be obtained by performing integration for differential plane dF on dθ under an appropriate boundary condition.

In the light source module, the method for design is the same according to the present invention mentioned above, the light source module is a line light source such as a Cold Cathode Fluorescence Lamp (CCFL) or a LED array, and the protrusions on the reflector are such as the polygon rib protrusions or the semi-round rib protrusions.

In the light source module and the method for design the same according to the present invention mentioned above, a reflective layer is selectively disposed on some or all portions of the reflector surface, such as the protrusion surface, other portions in the reflector, curve F, and reflective surface S. The reflective layer is made of Al, Sn, SiO₂, or the material having good light reflecting capability such as synthesized papers.

The present invention intentionally designs the reflector as a curve or as an irregular surface having protrusions, so that the light behind the lamp is reflected to the high reflecting area of the reflector via the protrusions mentioned above, or reflected to the reflective surface S of the reflector via the curve mentioned above, and finally output from the light output section. Such design can effectively utilize the light originally blocked by the lamp. Therefore, the light source module of the present invention improves the light source utilization efficiency to a certain level.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a structure diagram of a conventional light source module.

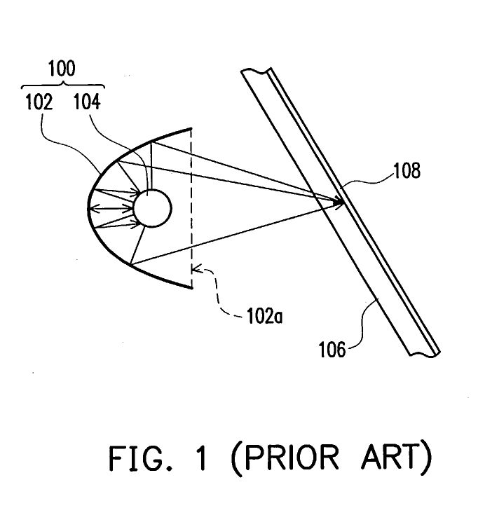

FIG. 2A and FIG. 2B schematically show structure diagrams of a light source module of the first embodiment according to the present invention.

FIG. 3 schematically shows a structure diagram of a light source module of the second embodiment according to the present invention.

FIG. 4 schematically shows a diagram of the curve F and light proceeding vectors \vec{A}, \vec{B}, \vec{C} in FIG. 3.

### DESCRIPTION OF THE PREFERRED EMBODIMENTS

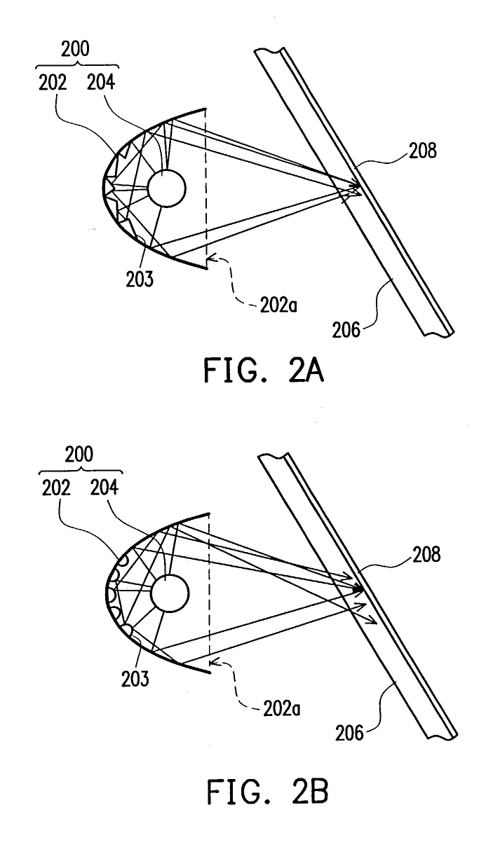

FIG. 2A and FIG. 2B schematically show structure diagrams of a light source module of the first embodiment according to the present invention. Referring to FIG. 2A, the light source module 200 mainly comprises a reflector 202 and a lamp 204. The lamp 204 is disposed inside the reflector 202, and the lamp 204 is a line light source such as a Cold Cathode Fluorescence Lamp (CCFL) or a LED array. The light emitted by the lamp 204 is output from the light output section 202a via the curve design of the reflector 202. The light focused by the reflector 202 emits on the document 208, and the light reflected by the document 208 emits into the optical scanning module of the scanner. The document 208 mentioned above is for example placed on a document plate 206 of the scanner case for performing the scanning operation, and the document plate 206 for placing the document 208 is, for example, made of a transparent material, so that the light (image) can be smoothly reflected from the document 208, and then captured by the optical scanning module.

Referring to both FIG. 2A and FIG. 2B, the reflector 202 of the present invention comprises a light output section 202a, and the portion of the reflector 202 corresponding to the light output section 202a comprises at least one protrusion 203. The protrusions 203 are such as the polygon rib protrusions (as shown in FIG. 2A) or the semi-round rib protrusions (as shown in FIG. 2B). As shown in FIG. 2A and FIG. 2B, the protrusions 203 on the reflector 202 are used as a reflective surface so that the light behind the lamp 204 is reflected to other protrusions 203 or other portions of the reflector 202, and the light is then output from the light output section 202a. Therefore, the position and orientation arrangement for the protrusion 203 is quite important.

In the present embodiment, a reflective layer (not shown) is, for example, disposed selectively on some or all portions of the protrusion surface and/or other areas inside the reflector 202. The reflective layer is made of Al, Sn, SiO₂, or material having good light reflecting capability such as synthesized papers.

Compared with the conventional technique, in the present invention, the protrusion 203 on the reflector 202 can reflect the light behind the lamp 204 so that the possibility that the lamp 204 might block the light can be significantly reduced, and the light source utilization efficiency of the light source module is significantly improved.

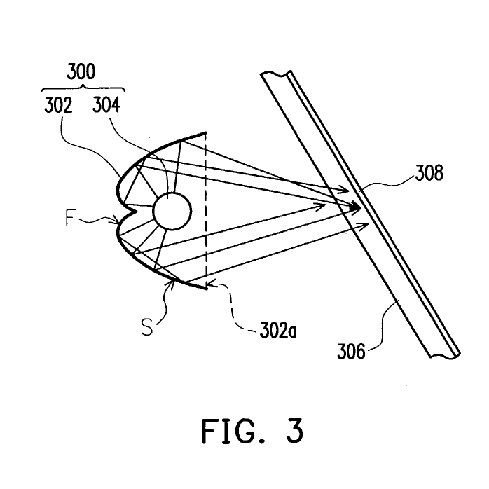

FIG. 3 schematically shows a structure diagram of a light source module of the second embodiment according to the present invention. Referring to FIG. 3, the light source module 300 of the present embodiment mainly comprises a reflector 302 and a lamp 304. The lamp 304 is disposed inside the reflector 302, and the lamp 304 is a line light source such as a Cold Cathode Fluorescence Lamp (CCFL) or a LED array. The light emitted by the lamp 304 is output from the light output section 302a via the curve F and/or the reflective surface S. The light focused by the reflector 302 emits on the document 308, and the light reflected by the document 308 emits into the optical scanning module of the scanner. The document 308 mentioned above is for example placed on a document plate 306 of the scanner case for performing the scanning operation, and the document plate 306 for placing the document 308 is for example made of a transparent material, so that the light (image) can be smoothly reflected from the document 308, and then captured by the optical scanning module.

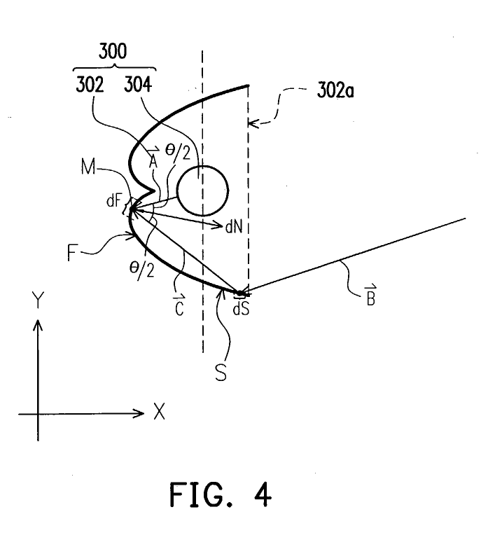

FIG. 4 schematically shows a diagram of the curve F and light proceeding vectors \vec{A}, \vec{B}, \vec{C} in FIG. 3. Referring to FIG. 4, the reflector 302 of the present embodiment for example comprises a curve F and a reflective surface S. Wherein, the reflective surface S is, for example, a plane, an elliptical curve, or a parabolic curve. It will be apparent to one of ordinary skill in the art that another known plane, curve, or irregular plane also can be selected as the reflective surface Sso as to fulfill the design requirement.

Referring to FIG. 4, from the perspective of microscopic view, the curve F is composed of a plurality of differential planes dF. Therefore, the equation of curve F is obtained by finding out the equation for each differential plane dF and performing integration on them. The step (a)˜step (e) shown below are used for describing the method for designing (deducting) the curve F in the reflector 302.

(a) Assuming that the equation of the reflective surface S is known, in the present embodiment, the reflective surface S is, for example, assumed as an elliptical curve or a parabolic curve mentioned above, or a plane.

(b) The differential plane dF is related to vectors \vec{A}, \vec{B}, \vec{C}, wherein A is a proceeding vector of the light emitted from each unit area on the back of the lamp; \vec{B} is a proceeding vector of the light reflected from each unit of the differential plane dS when the document is being scanned; and \vec{C} is a reflective vector of \vec{B} corresponding to each unit area of dS on the reflective surface S.

(c) Calculate a angle bisectvector according to two vectors \vec{A} and \vec{C}, the angle bisectvector is the normal vector dN of the differential plane dF. Accordingly, the angle between the normal vector dN and the vector \vec{A}, \vec{B} is θ/2. Then, assuming that the calculated normal vector dN is (a, b) and is on the X-Y plane, the equation of differential plane dF is assumed as ax+by+c=0.

(d) Calculating a focal point M from two vectors \vec{A} and \vec{C}, since the focal point M is on the differential plane dF, the coordinate of focal point M is brought into ax+by+c=0, so as to calculate a value of c.

(e) Performing integration for differential plane dF on dS, and providing an appropriate boundary condition, so as to obtain an equation of curve F, i.e. F=∫dFdS=∫(ax+by+c)dS. However, in step (e), the equation of curve F also can be obtained by performing integration for differential plane dF on dθ under an appropriate boundary condition (for θ).

The curve F obtained by the deducting process mentioned above can reflect the light behind the lamp 304 onto the reflective surface S of the reflector 302 so as to fully resolve the poor light source utilization efficiency problem. In other words, with the structure design of the present embodiment, the light behind the lamp 304 is output from the light output section 302a after at least two times reflection.

In the present embodiment, a reflective layer (not shown) is, for example, selectively disposed on some or all portions of the internal surface of the reflector, i.e., the curve F and the reflective surface S. The reflective layer is made of Al, Sn, SiO₂, or of material having good light reflecting capability such as synthesized papers.

The light source module and method for designing the same of the present invention have at least the following advantages:

1. In the light source module of the present invention, the light behind the lamp is output from the light output section via the protrusions or the curve F after reflection occurs at least twice, so that the light source utilization efficiency is significantly improved.

2. The curve F of the present invention is the result of the light path analysis deduction, therefore the curve F can optimize the light source utilization efficiency of the light source module.

3. In the light source module of the present invention, a reflective layer is selectively disposed on some or all portions of the internal surface of the reflector, and the reflective layer is made of Al, Sn, SiO₂, or synthesized papers, so as to improve the light reflecting capability of the reflector.

Although the invention has been described with reference to a particular embodiment thereof, it will be apparent to one of ordinary skill in the art that modifications to the described embodiment may be made without departing from the spirit of the invention. Accordingly, the scope of the invention will be defined by the attached claims not by the above detailed description.

What is claimed is:

1. A light source module, comprising:
a reflector, wherein the reflector comprises a light output section, and a portion of the reflector corresponding to the light output section comprises at least one protrusion; and
a lamp, disposed in the reflector, wherein the lamp is suitable for emitting a light, and the light is reflected onto other portions of the reflector via the protrusions, and then output from the light output section.

2. The light source module of claim 1, wherein the lamp is a line light source.

3. The light source module of claim 2, wherein the line light source comprises either a Cold Cathode Fluorescence Lamp (CCFL) or a LED array.

4. The light source module of claim 2, wherein the protrusion is either a polygon rib protrusion or a semi-round rib protrusion.

5. The light source module of claim 1, further comprising a reflective layer, wherein the reflective layer is disposed on the protrusion surface.

6. The light source module of claim 5, wherein the reflective layer is made of a material from one of the Al, Sn, SiO₂, and synthesized papers.

7. A light source module, comprising:
a reflector, wherein the reflector comprises a light output section, and a portion of the reflector corresponding to the light output section is a curve F, and a portion of the reflector adjacent to the light output section is a reflective surface S, the curve F is connected to the reflective surface S, and the curve F=∫dFdS=∫(ax+by+c)dS, wherein dF is a differential plane that constructs the curve F, dS is a differential plane that constructs the reflective surface S, and (a, b) is a normal vector of the differential plane dF; and
a lamp, disposed in the reflector, wherein the lamp is suitable for emitting a light, and the light is delivered onto the reflective surface S via the curve F after reflection occurs at least once, and then output from the light output section.

8. The light source module of claim 7, wherein the lamp is a line light source, and the line light source is extended in parallel with z axis.

9. The light source module of claim 8, wherein the line light source comprises either a Cold Cathode Fluorescence Lamp (CCFL) or a LED array.

10. The light source module of claim 7, further comprising a reflective layer, wherein the reflective layer is disposed on the surface of the curve F and the reflective surface S.

11. The light source module of claim 10, wherein the reflective layer is made of a material from one of the Al, Sn, SiO₂, and synthesized papers.

12. The light source module of claim 7, wherein the reflective surface S comprises either an elliptical curve or a parabolic curve, and a plane.

13. A method for designing the light source module, comprising:
providing a reflector, wherein the reflector comprises a light output section, and a portion of the reflector corresponding to the light output section is designed as a curve F, and a portion of the reflector adjacent to the light output section is a reflective surface S that is connected to the curve F, and the curve F=∫dFdS=∫(ax+by+c)dS, wherein dF is a differential plane that constructs the curve F, dS is a differential plane that constructs the reflective surface S, and (a, b) is a normal vector of the differential plane dF; and
disposing a lamp in the reflector, so that a light emitted by the lamp is delivered onto the reflective surface S via the curve F after reflection occurs at least once, and then output from the light output section.

14. The method for designing the light source module of claim 13, wherein the method for designing the curve F comprises:
(a) assuming the equation of the reflective surface S is known;
(b) the differential plane dF is related to vectors \vec{A}, \vec{B}, \vec{C}, wherein \vec{A} is a proceeding vector of the light emitted from each unit area on the back of the lamp; \vec{B} is a proceeding vector of the light reflected from each unit of the differential plane dS when the document is being scanned; and \vec{C} is a reflective vector of \vec{B} corresponding to each unit area of dS on the reflective surface S;
(c) calculating a angle bisectvector according to two vectors \vec{A} and \vec{C}, and the angle bisect vector is a normal vector dN of the differential plane dF, and assuming that the calculated normal vector dN is (a, b) and the normal vector is on the X-Y plane, the equation of differential plane dF is assumed as ax+by+c=0;
(d) calculating a focal point M from two vectors \vec{A} and \vec{C}, since the focal point M is on the differential plane dF, a coordinate of focal point M is brought into ax+by+c=0, so as to calculate a value of c; and
(e) performing integration for differential plane dF on either dS or dθ, and providing a boundary condition, so as to obtain the equation of curve F, i.e. F=∫dFdS=∫(ax+by+c)dS.

15. The method for designing the light source module of claim 13, wherein the reflective surface S comprises either an elliptical curve or a parabolic curve, and a plane.

16. The method for designing the light source module of claim 13, wherein the lamp is a line light source, and the line light source is extended in parallel with z axis.

17. The method for designing the light source module of claim 16, wherein the line light source comprises either a Cold Cathode Fluorescence Lamp (CCFL) or a LED array.

18. The method for designing the light source module of claim 13, further comprising disposing a reflective layer on the surface of the curve F and the reflective surface S.

19. The method for designing the light source module of claim 18, wherein the reflective layer is made of a material from one of the Al, Sn, SiO₂, and synthesized papers.
